(19) United States
(12) Patent Application Publication
(10) Pub. No.: US 2015/0172967 A1
(43) Pub. Date: Jun. 18, 2015

(54) BASE STATION AND CELL SELECTION METHOD

(71) Applicant: FUJITSU LIMITED, Kawasaki-shi (JP)

(72) Inventors: Hiroaki Senoo, Kawasaki (JP); Hideto Furukawa, Yokohama (JP)

(21) Appl. No.: 14/564,867

(22) Filed: Dec. 9, 2014

(30) Foreign Application Priority Data
Dec. 13, 2013 (JP) 2013-258555

(51) Int. Cl. H04W 36/00

(52) U.S. Cl. CPC H04W 36/0061

(57) ABSTRACT

A base station including: an antenna configured to wirelessly communicate with a terminal that is able to communicate with the base station and another base station in parallel, the other base station being selected from a plurality of other base stations, and a processor configured to select the other base station based on a plurality of at least one parameter, each at least one parameter being associated with each period during which the terminal stays in each cell formed by each of the plurality of other base stations.

### CROSS-REFERENCE TO RELATED APPLICATION

This application is based upon and claims the benefit of priority of the prior Japanese Patent Application No. 2013-258555 filed on Dec. 13, 2013, the entire contents of which are incorporated herein by reference.

### FIELD

The embodiments discussed herein are related to a base station and a cell selection method.

### BACKGROUND

In recent years, communication using a plurality of frequency bands is studied to achieve a wider bandwidth. For example, in a communication standard 3rd Generation Partnership Project Radio Access Network Long Term Evolution (3GPP LTE)-Advanced, a technique called carrier aggregation (CA) is studied. The CA is a communication technique that uses a plurality of component carriers. In other words, the carrier aggregation is a technique that can perform communication by using different frequency bands at the same time (namely, in parallel). In short, the CA is a communication technique that uses a plurality of cells. Here, the component carrier means one unit of frequency band that can be used for communication. In the description below, the component carrier may be represented as “CC”.

When performing the CA, first, a cell (hereinafter referred to as a primary cell (P-Cell)) corresponding to a first CC, which is a main CC, is set. Then, a cell (hereinafter referred to as a secondary cell (S-Cell)) corresponding to a second CC deferent from the first CC is set so that the P-Cell and the S-Cell are aggregated. For example, the maximum number of candidates of S-Cell that can be set is five. At least one S-Cell is set from among the candidates of S-Cell and the CA of P-Cell and S-Cell is performed. Here, the “cell” is defined based on a “communication area” and a “channel frequency” of one base station. The “communication area” may be the entire area which a radio wave transmitted from the base station can reach by a predetermined power value or more (hereinafter may be referred to as a “cover area”) or maybe a divided area (so-called a sector) obtained by dividing the cover area. The “channel frequency” is one unit of frequency used by the base station for communication and is defined by a central frequency and a bandwidth. In other words, the “channel frequency” corresponds to the CC described above. The “channel frequency” is a part of an “operating band” allocated to the entire system.

A terminal can be connected to only one cell when a wireless line is set. Therefore, the cell connected to the terminal when the wireless line is set is the P-Cell. Thereafter, the P-Cell is changed when a handover or the like is performed. Further, candidates of S-Cell can be added, deleted, or changed. The candidates of S-Cell are added and deleted by a control signal in a radio resource control (RRC) layer. Specifically, a list indicating the P-Cell and the candidates of S-Cell is transmitted from the base station to the terminal. A process to set the candidates of S-Cell into a state (activate state) where the candidates of S-Cell are actually used or a state (deactivate state) where the candidates of S-Cell are not used is performed by a control signal in a media access control (MAC) layer. As a result, the terminal can use the candidates of S-Cell which are included in the list and are in the activate state. The addition/deletion process of the candidates of S-Cell is a process in the RRC layer (L3), so that the response speed is low, but the reliability is high. On the other hand, the activate/deactivate process of the candidates of S-Cell is a process in the MAC layer (L2), so that the response speed is high, but the reliability is lower than that in the L3.

Conventionally, various ideas have been devised to increase the transmission capacity (hereinafter may be referred to as “system capacity”) in a communication system. For example, in the 3GPP LTE, a technique for increasing the system capacity by using “small cell” in addition to “macro cell” is discussed. The “macro cell” is a cell of a base station that can transmit by using high transmission power, that is, a base station that covers a large area. The “small cell” is a cell of a base station that transmits by using low transmission power, that is, a base station that covers a small area. A network in which a plurality of base stations whose transmission powers and types are different from each other coexist may be called a “heterogeneous network”.

As illustrated in FIG. 1, in the heterogeneous network in which small cells are densely arranged to overlap the cover area of the macro cell, it is proposed that the macro cell is used as the P-cell and the small cells are used as the S-Cells. Thereby, it is possible to reduce the frequency of handover occurring due to change of P-Cell.

3GPP TS 36.300 V11.7.0, Release 11, 2013-09, 3GPP TS 36.213 V11.4.0, “Physical layer procedures (Release 11)”, 2013-09, and 3GPP TS 36.212 V11.3.0, “Multiplexing and channel coding (Release 11)”, 2013-06 are examples of related art.

### SUMMARY

According to an aspect of the invention, a base station includes an antenna configured to wirelessly communicate with a terminal that is able to communicate with the base station and another base station in parallel, the other base station being selected from a plurality of other base stations, and a processor configured to select the other base station based on a plurality of at least one parameter, each at least one parameter being associated with each period during which the terminal stays in each cell formed by each of the plurality of other base stations.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a heterogeneous network;

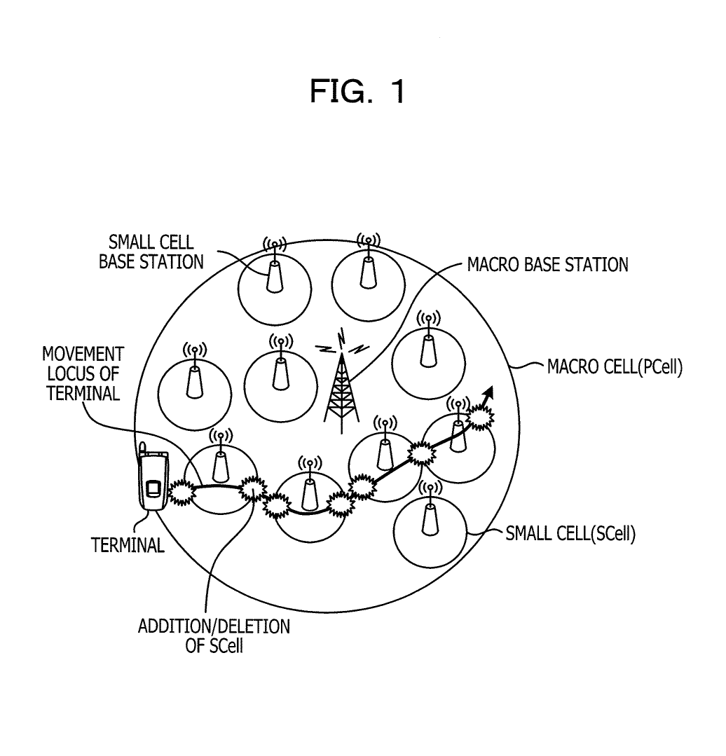

FIG. 2 is a diagram illustrating an example of a communication system of a first embodiment;

FIG. 3 is a block diagram illustrating an example of a base station of the first embodiment;

FIG. 4 is a flowchart illustrating an example of a processing operation of a base station of the first embodiment;

FIG. 5 is a diagram for explaining an example of an estimation method of a moving speed of terminal;

FIG. 6 is a diagram for explaining a selection method of S-Cell candidates;

FIG. 7 is a diagram for explaining a selection method of S-Cell candidates;

FIG. 8 is a diagram illustrating a hardware configuration example of a base station of a second embodiment;

FIG. 9 is a diagram illustrating an example of a processing operation of the base station of the second embodiment;

FIG. 10 is a diagram illustrating a hardware configuration example of a base station of a third embodiment;

FIG. 11 is a diagram illustrating an example of a processing operation of the base station of the third embodiment; and

FIG. 12 is a diagram illustrating another hardware configuration example of a base station.

### DESCRIPTION OF EMBODIMENTS

However, if candidates of S-Cell are frequently changed as the terminal moves, there is a problem that the traffic of the control signal increases.

The disclosed technique is made in view of the above situation and an object of the disclosed technique is to provide a base station and a cell selection method which can reduce the traffic of the control signal.

Hereinafter, embodiments of the base station and the cell selection method disclosed by the present application will be described in detail with reference to the drawings. The embodiments do not limit the base station and the cell selection method disclosed by the present application. In the embodiments, components having the same function are denoted by the same reference numerals and redundant description will be omitted. In the embodiments, the same steps are denoted by the same reference numerals and redundant description will be omitted.

### First Embodiment

### Overview of Communication System

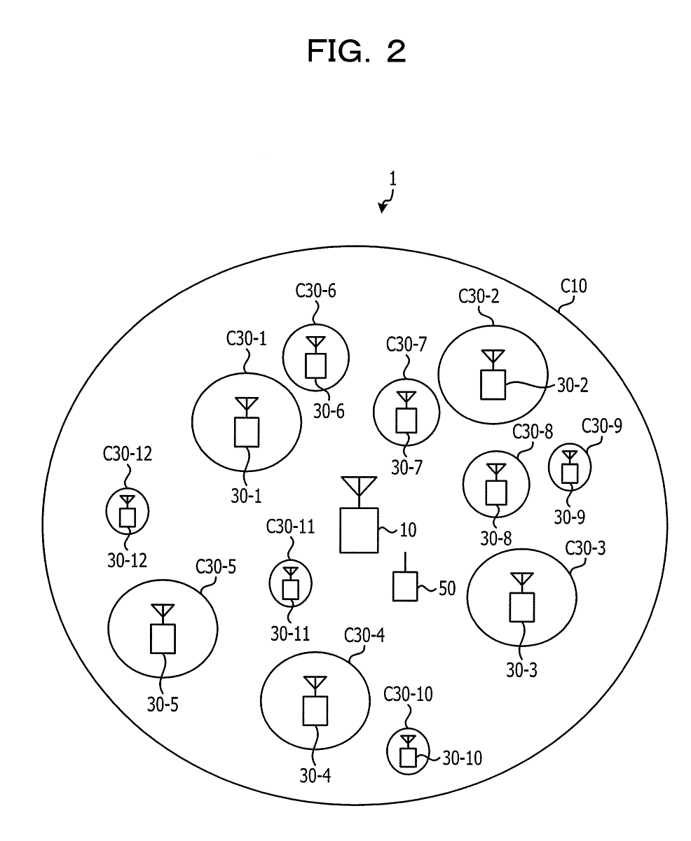

FIG. 2 is a diagram illustrating an example of a communication system of a first embodiment. In FIG. 2, the communication system 1 includes a base station 10, base stations 30-1 to 30-12, and a terminal 50. The numbers of the base station 10, the base stations 30, and the terminal 50 illustrated in FIG. 2 are an example and are not limited to this. In the description below, when the base stations 30-1 to 30-12 are not distinguished from each other, the base stations 30-1 to 30-12 are collectively referred to as the “base station 30”. The base station 10 is, for example, a macro base station, and the base station 30 is, for example, a small base station. In FIG. 2, a macro cell C10 is defined by a cover area of the base station 10 and a first CC. In the macro cell C10, a small cell C30 that covers a cover area smaller than the macro cell C10 is defined by a cover area of the base station 30 and a CC different from the first CC. Each of the small cells C30-1 to C30-12 may have the same CC, may have a partially shared CC, or may have a CC different from each other. In the description below, for ease of description, it is assumed that the small cells C30-1 to C30-12 have the same second CC. As an example, FIG. 2 illustrates a case in which the small cells C30 and the macro cell C10 overlap each other.

The terminal 50 is a terminal that can perform communication by using a first cell and a second cell at the same time. The first cell is, for example, the macro cell C10, and the second cell is, for example, the small cell C30. The first cell is, for example, the aforementioned P-Cell, and the second cell is, for example, the aforementioned S-Cell.

The base station 10 acquires a parameter related to a time (period) desired for the terminal 50 to pass through (or stay within) each of a plurality of cells except for the macro cell C10 (hereinafter may be referred to as a “pass-through time parameter”) from the base station of each cell. The plurality of cells except for the macro cell C10 may include cells outside the macro cell C10 of the base station 10. However, in the description below, it is assumed that the plurality of cells except for the macro cell C10 does not include cells outside the macro cell C10 of the base station 10. In other words, here, the plurality of cells except for the macro cell C10 are the small cells C30-1 to C30-12.

The pass-through time parameter is, for example, at least either one of a parameter related to the cell radius of each of the plurality of small cells C30 (hereinafter may be referred to as a “cell radius parameter”) and a moving speed of the terminal 50. The “cell radius parameter” includes, for example, a transmission power of the base station 30 corresponding to a target small cell C30. In other words, the base station 10 acquires a parameter indicating that each of the plurality of small cells C30 has a different cell radius as the cell radius parameter.

The base station 10 selects candidates of S-Cell for the terminal 50 from among the plurality of small cells C30 based on the acquired pass-through time parameters.

Then, the base station 10 notifies the terminal 50 of a list including a selected P-Cell and the selected candidates of S-Cell. Further, the base station 10 notifies the terminal 50 of S-Cells that can be actually used from among the selected candidates of S-Cell.

The terminal 50 performs communication by the CA by using the P-Cell and the S-Cells that can be actually used.

In this way, the base station 10 selects the candidates of S-Cell based on the time desired for the terminal 50 to pass through, so that it is possible to remove cells where the time desired to pass through is small, that is, cells that are highly probable to frequently cause change of the candidates of S-Cell, from the candidates of S-Cell. Thereby, it is possible to reduce the traffic of the control signal.

Configuration Example of Base Station

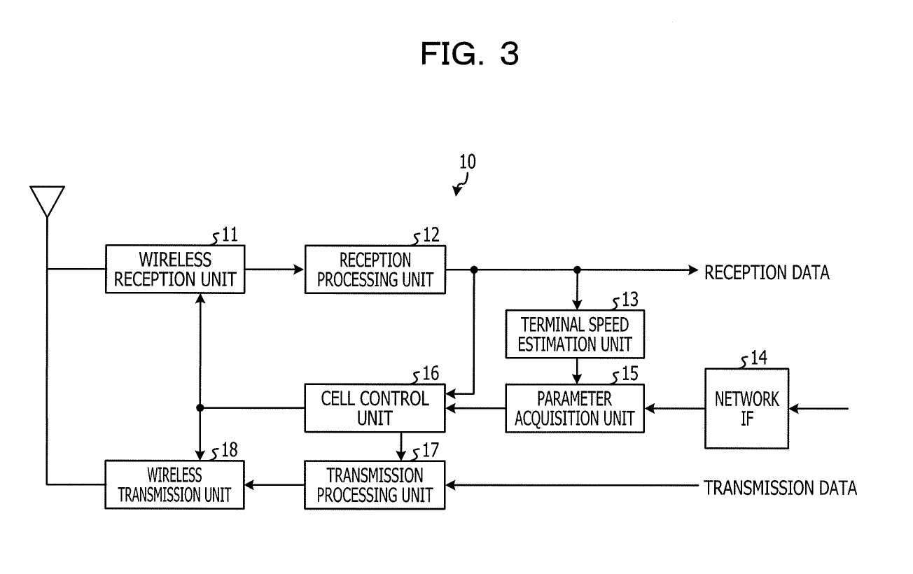

FIG. 3 is a block diagram illustrating an example of the base station of the first embodiment. In FIG. 3, the base station 10 includes a wireless reception unit 11, a reception processing unit 12, a terminal speed estimation unit 13, a network interface (IF) 14, a parameter acquisition unit 15, a cell control unit 16, a transmission processing unit 17, and a wireless transmission unit 18.

The wireless reception unit 11 performs predetermined wireless reception processing, that is, down-conversion, analog-digital conversion, and the like, on a reception signal received through an antenna, and outputs the reception signal after the wireless reception processing to the reception processing unit 12.

The reception processing unit 12 performs predetermined reception processing on the reception signal received from the wireless reception unit 11 and outputs the reception signal (reception data) after the reception processing to the terminal speed estimation unit 13, the cell control unit 16, and subsequent stage functional units. Here, the predetermined reception processing includes demodulation processing and decoding processing. When the reception signal is an Orthogonal Frequency Division Multiplexing (OFDM) signal, the predetermined reception processing includes Fast Fourier Transform (FFT) processing.

The terminal speed estimation unit 13 estimates a moving speed of the terminal 50 based on “sequence” included in the reception data received from the reception processing unit 12. An example of the method of estimating the moving speed will be described later.

The network IF 14 receives the cell radius parameter transmitted from each base station 30 and outputs the cell radius parameter to the parameter acquisition unit 15.

The parameter acquisition unit 15 acquires the “pass-through time parameter” and outputs the acquired pass-through time parameter to the cell control unit 16. For example, the parameter acquisition unit 15 acquires information related to the moving speed of the terminal 50 from the terminal speed estimation unit 13 and acquires the cell radius parameter from the network IF 14. In other words, the parameter acquisition unit 15 acquires a parameter indicating that each of the plurality of small cells C30 has a different cell radius as the cell radius parameter. Then, the parameter acquisition unit 15 outputs the acquired information related to the moving speed of the terminal 50 and the acquired cell radius parameter to the cell control unit 16. When the terminal 50 can calculate the moving speed of the terminal 50 itself by using, for example, a Global Positioning System (GPS) function, the parameter acquisition unit 15 may acquire the moving speed reported from the terminal 50. It is allowed that the parameter acquisition unit 15 does not acquire the information related to the moving speed of the terminal 50 but acquires the cell radius parameter.

The cell control unit 16 selects the candidates of S-Cell for the terminal 50 from among the plurality of small cells C30 based on the pass-through time parameters acquired from the parameter acquisition unit 15. For example, the cell control unit 16 selects the candidates of S-Cell for the terminal 50 from among the plurality of small cells C30 based on the magnitude relation between a ratio and a first threshold value, where the ratio is that between the cell radius corresponding to the cell radius parameter acquired from the parameter acquisition unit 15 and the moving speed of the terminal 50. The small cells C30 included in a measurement report may be used as a selection parent population. The cell control unit 16 may compare the cell radius corresponding to the cell radius parameter acquired from the parameter acquisition unit 15 with a predetermined threshold value (that is, a “cell radius threshold value”) and select small cells C30 whose cell radius is greater than or equal to the cell radius threshold value as the candidates of S-Cell.

The cell control unit 16 may select small cells C30, the distance from which to the terminal 50 is smaller than or equal to a second threshold value, from among the small cells C30 selected as the candidates of S-Cell as described above, as final candidates of S-Cell. Here, small cells C30 that are not included in the measurement report may be included in the selection parent population. The cell control unit 16 may set the second threshold value so that the higher the moving speed of the terminal 50, the greater the second threshold value. The cell control unit 16 may set the cell radius threshold value applied to the small cells C30 so that the greater the distance between the terminal 50 and the small cell C30, the greater the cell radius threshold value. The cell control unit 16 may set the cell radius threshold value so that the higher the moving speed of the terminal 50, the greater the cell radius threshold value. Alternatively, the cell control unit 16 may preferentially select small cells C30 in descending order of the cell radius as the candidates of the cell. Alternatively, the cell control unit 16 may preferentially select small cells C30 in ascending order of the distance between the small cell C30 and the terminal 50 as the candidates of the cell.

Then, the cell control unit 16 transmits the selected P-Cell and candidates of S-Cell to the terminal 50 through the transmission processing unit 17 and the wireless transmission unit 18. Further, the cell control unit 16 selects S-Cells that will be actually used from the candidates of S-Cell and transmits the selected S-Cells to the terminal 50 through the transmission processing unit 17 and the wireless transmission unit 18. Then, the cell control unit 16 outputs information related to the P-Cell and the S-Cells that will be used to the wireless reception unit 11 and the wireless transmission unit 18. Thereby, the wireless reception unit 11 can receive a signal transmitted from the terminal 50 at a frequency corresponding to the P-Cell and the S-Cells. The wireless transmission unit 18 can transmit a signal to the terminal 50 at a frequency corresponding to the P-Cell and the S-Cells.

Transmission data and a control signal (including information related to the P-Cell and the S-Cells) are inputted into the transmission processing unit 17 and the transmission processing unit 17 performs predetermined transmission processing on the transmission data and the control signal and outputs the transmission data and the control signal to the wireless transmission unit 18. The predetermined transmission processing includes encoding processing and modulation processing. When a transmission signal is an OFDM signal, the predetermined transmission processing includes Inverse Fast Fourier Transform (IFFT) processing.

The wireless transmission unit 18 performs predetermined wireless transmission processing, that is, digital-analog conversion, up-conversion, and the like, on the transmission signal after the predetermined transmission processing and transmits the transmission signal after the wireless transmission processing through an antenna.

Operation Example of Communication system

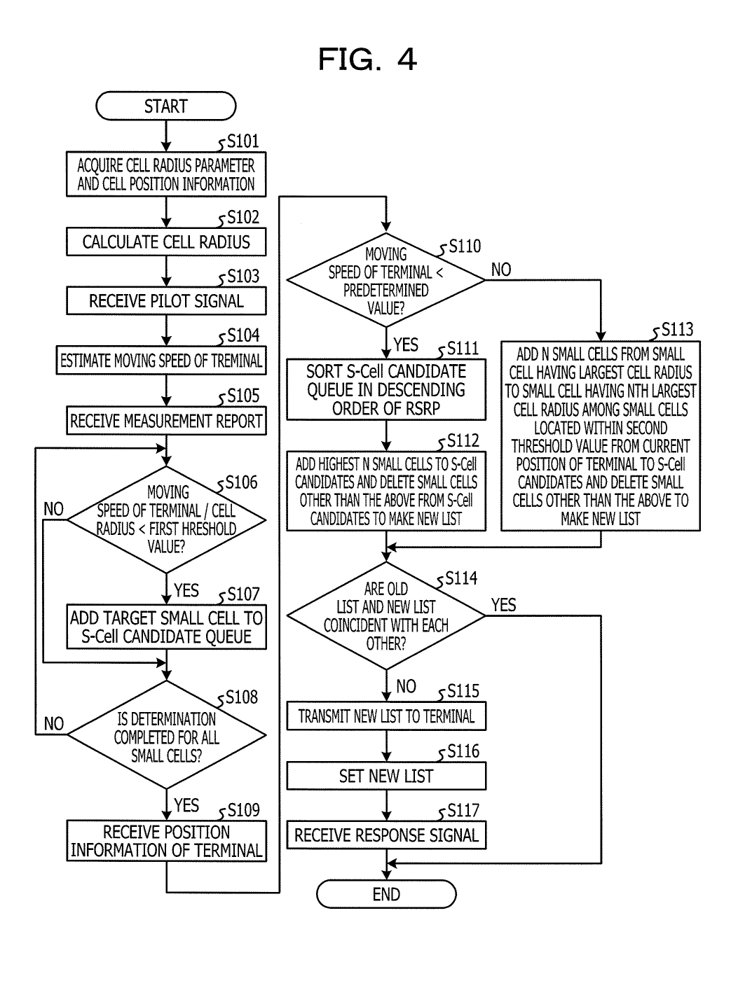

An example of a processing operation of the communication system 1 having the aforementioned configuration will be described. In particular, an example of a processing operation of the base station 10 will be described. FIG. 4 is a flowchart illustrating an example of a processing operation of the base station of the first embodiment.

In the base station 10, the parameter acquisition unit 15 acquires the cell radius parameter and cell position information from the network IF 14 (step S101). The cell radius parameter and the cell position information are information related to the small cell C30 of each base station 30.

The cell control unit 16 calculates the cell radius based on the cell radius parameter acquired in step S101 (step S102). The cell radius parameter includes, for example, a transmission power and a base station transmission antenna gain of the base station 30 corresponding to the small cell C30. The cell radius d is calculated by using, for example, the formula (1) described below. Specifically, free-space propagation is assumed and Friis transmission formula is used. The cell radius d may be obtained based on actual measurement or experimental rule.

d=c/(4πf×10^{(Pr-Gt-GR-Pt)/20}) (1)

Here, f is a carrier frequency [Hz], Pt is a set transmission power [dBm] of the base station 30 corresponding to the small cell C30, and Gt is a base station transmission antenna gain [dB] of the base station 30. Pr is a terminal reception sensitivity [dBm] of the terminal 50 and Gr is a terminal reception antenna gain [dB]. Further, c is the light speed [m/s].

The wireless reception unit 11 and the reception processing unit 12 receive a pilot signal (sequence) transmitted from the terminal 50 (step S103).

The terminal speed estimation unit 13 estimates the speed of the terminal 50 based on the pilot signal received in step S103 (step S104). Information related to the calculated speed of the terminal 50 is outputted to the parameter acquisition unit 15.

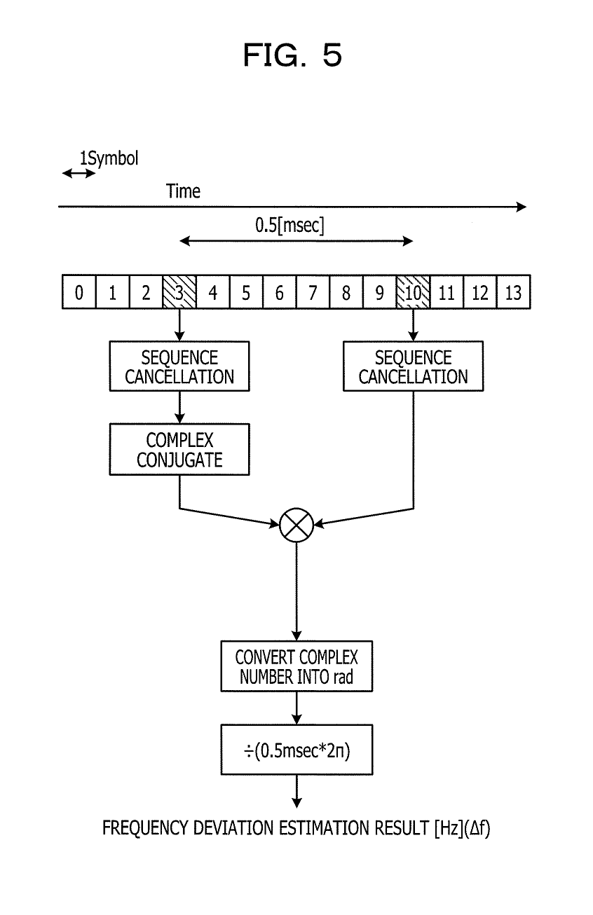

For example, the speed of the terminal 50 is obtained as described below. FIG. 5 is a diagram for explaining an example of an estimation method of the moving speed of the terminal 50.

In FIG. 5, it is assumed that a pilot signal is mapped to the fourth symbol and the eleventh symbol included in one sub-frame and the pilot signals are transmitted from the terminal 50. First, the terminal speed estimation unit 13 performs a process (sequence cancellation process) to cancel effects of pilot sequence to each of the pilot signal mapped to the fourth symbol and the pilot signal mapped to the eleventh symbol. Thereby, effects of propagation path and effects of the Doppler effect remain. Then, the terminal speed estimation unit 13 calculates a complex conjugate of a signal obtained from the reception pilot signal mapped to the fourth symbol by the sequence cancellation process and multiplies the calculation result and a signal obtained from the reception pilot signal mapped to the eleventh symbol by the sequence cancellation process. Thereby, the effects of propagation path are cancelled and the effects of the Doppler effect remain. Then, the terminal speed estimation unit 13 converts the multiplication result, which is a complex number, into radian (rad) and obtains a frequency deviation estimation result [Hz] by further dividing the radian by 0.5 msec and 2π. The moving speed of the terminal 50 is estimated by substituting the frequency deviation estimation result [Hz] in the following formula (2):

v=c×Δf/2f (2)

Here, v is the moving speed [m/s] of the terminal 50, c is the light speed [m/s], Δf is the frequency deviation estimation result [Hz], and f is the carrier frequency [Hz].

The wireless reception unit 11 and the reception processing unit 12 receive a measurement report from the terminal 50 (step S105). The received measurement report is outputted to the cell control unit 16. The measurement report includes at least either one of a power received by the terminal 50 of a reference signal transmitted from each base station 30 (reference signal received power (RSRP)) and a reference signal received quality (RSRQ) obtained from the RSRP.

First, the cell control unit 16 selects one target small cell, calculates a ratio of the terminal moving speed to the cell radius for the target small cell, and determines whether or not the calculated ratio is smaller than the first threshold value (step S106).

When the ratio of the target small cell is smaller than the first threshold value (step S106: Yes), the cell control unit 16 adds the target small cell to an S-Cell candidate queue (step S107). On the other hand, when the ratio of the target small cell is greater than or equal to the first threshold value (step S106: No), the cell control unit 16 does not add the target small cell to the S-Cell candidate queue.

The cell control unit 16 determines whether or not the determination of step S106 is performed for all the small cells of the base stations 30 from which the cell radius parameter and the like are received (step S108), and when one or more small cells that are not determined remain (step S108: No), the cell control unit 16 changes the target small cell and performs the determination process of step S106. On the other hand, when the determination of step S106 is performed for all the small cells (step S108: Yes), the cell control unit 16 ends the determination process of step S106. The small cells to be determined in step S106 may be limited to small cells included in the measurement report, that is, small cells for which the terminal 50 reports RSRP and the like.

The wireless reception unit 11 and the reception processing unit 12 receive position information of the terminal 50 (step S109). The received position information is outputted to the cell control unit 16.

The cell control unit 16 determines whether or not the moving speed of the terminal 50 is smaller than a predetermined value (step S110).

When the moving speed of the terminal 50 is smaller than the predetermined value (step S110: Yes), the cell control unit 16 sorts a plurality of small cells C30 in the S-Cell candidate queue in descending order of RSRP (step S111).

The cell control unit 16 adds (selects) the highest N small cells C30 in the sorted S-Cell candidate queue (N is a natural number greater than or equal to 2) to (as) S-Cell candidates, and deletes (removes) the small cells C30 other than the above from the S-Cell candidates to make a new list (step S112).

When the moving speed of the terminal 50 is greater than or equal to the predetermined value (step S110: No), the cell control unit 16 adds N small cells C30 from the small cell C30 having the largest cell radius to the small cell C30 having the Nth largest cell radius among a plurality of small cells located within the second threshold value from the current position of the terminal 50 to S-Cell candidates, and deletes (removes) the small cells C30 other than the above from the S-Cell candidates to make a new list (step S113). The selection parent population of the S-Cell candidates in step S113 includes the small cells in the S-Cell candidate queue formed in step S107, but does not include the small cells that are not added to the S-Cell candidate queue. The selection parent population of the S-Cell candidates in step S113 may include the small cells that are not included in the measurement report, that is, the small cells for which the terminal 50 does not report RSRP and the like.

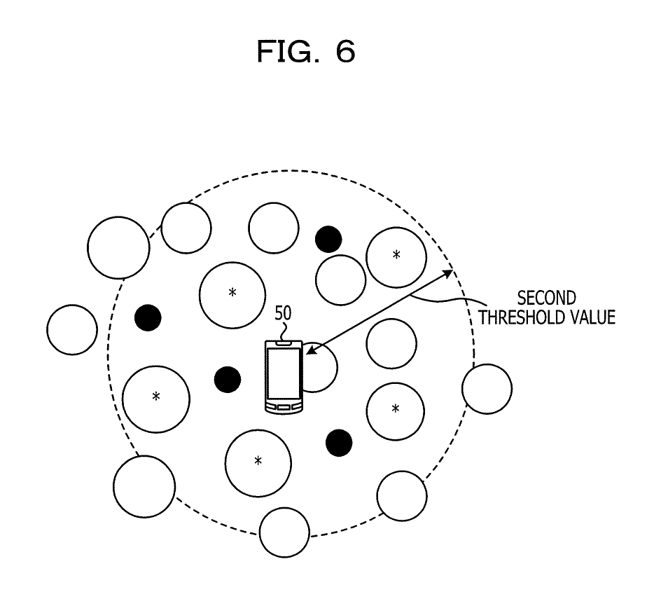

FIG. 6 is a diagram for explaining a selection method of the S-Cell candidates. In FIG. 6, each of circles drawn by a solid line represents the small cell C30. In FIG. 6, the circle drawn by a dashed line represents positions at a distance of the second threshold value away from the terminal 50. In FIG. 6, the black circles represent the small cells C30 that are removed from the S-Cell candidates by the determination in step S106. When the aforementioned N is 5, as illustrated in FIG. 6, the small cells C30 attached with a * mark, that is, five small cells C30 from the small cell with the largest cell radius to the small cell with the fifth largest cell radius among a plurality of small cells C30 located within the second threshold value from the current position of the terminal 50, are added to the S-Cell candidates.

Here, the cell control unit 16 may set the second threshold value so that the higher the moving speed of the terminal 50, the greater the second threshold value.

The cell control unit 16 may select small cells C30 whose cell radius is greater than or equal to the cell radius threshold value from among the plurality of small cells C30 located within the second threshold value from the current position of the terminal 50 as the candidates of S-Cell.

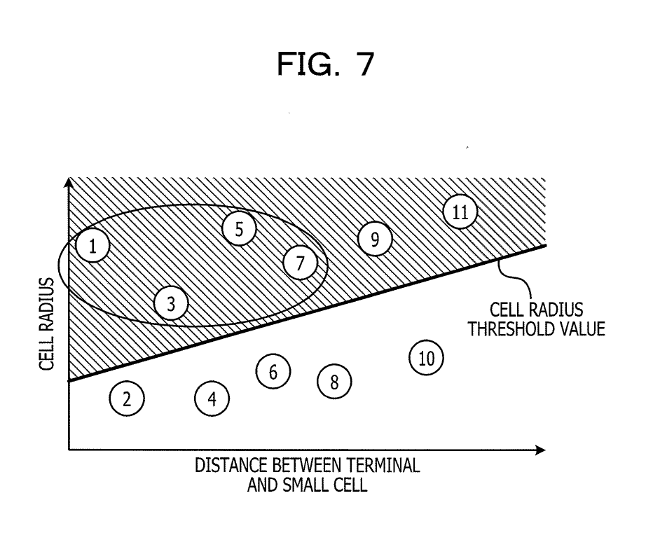

Further, as illustrated in FIG. 7, the cell control unit 16 may set the cell radius threshold value applied to the small cells C30 so that the greater the distance between the terminal 50 and the small cell C30, the greater the cell radius threshold value. In other words, as illustrated in FIG. 7, the cell control unit 16 may set a straight line indicating the cell radius threshold value to rise from left to right.

Further, the cell control unit 16 may set the cell radius threshold value so that the higher the moving speed of the terminal 50, the greater the cell radius threshold value. In other words, the straight line indicating the cell radius threshold value may be shifted in parallel so that the higher the speed of the terminal 50, the upper the straight line, and the lower the speed of the terminal 50, the lower the straight line. In FIG. 7, the cell radius threshold value is represented as a straight line with respect to the distance between the terminal 50 and the small cell C30, however, it is not limited to this, and the cell radius threshold value may be represented as a curved line.

Further, the smaller the distance between the small cell C30 and the terminal 50, the more preferentially the cell control unit 16 may select the small cell C30 as a candidate of the cell from among a plurality of small cells C30 whose cell radius exceeds the straight line indicating the cell radius threshold value. When N is four, as illustrated in FIG. 7, four small cells C30 (small cells 1, 3, 5, and 7 in FIG. 7) are selected as the candidates of S-Cell. Alternatively, the cell control unit 16 may preferentially select small cells C30 in descending order of the cell radius as the candidates of the cell. In this case, four small cells C30 (small cells 11, 5, 9, and 1 in FIG. 7) are selected as the candidates of S-Cell.

The cell control unit 16 determines whether or not the new list made in step S112 or step S113 is coincident with the old list (step S114).

When the new list and the old list are not coincident with each other (step S114: No), the cell control unit 16 transmits the new list to the terminal 50 through the transmission processing unit 17 and the wireless transmission unit 18 (step S115) and sets the new list in a scheduler (not illustrated in FIG. 3) in the base station 10 (step S116). Thereby, the scheduler can select S-Cells to be actually used from among the S-Cell candidates included in the new list. The new list may be included in an RRCConnectionReconfiguration message to be transmitted.

The cell control unit 16 receives a response signal through the wireless reception unit 11 and the reception processing unit 12 (step S117). The response signal is, for example, an RRCConnectionReconfigurationComplete message. When the new list and the old list are coincident with each other (step S114: Yes), the new list is not transmitted.

As described above, according to the present embodiment, in the base station 10, the parameter acquisition unit 15 acquires the pass-through time parameter related to the pass-through time for the terminal 50 to pass through each of a plurality of small cells C30 and the cell control unit 16 selects candidates of S-Cell for the terminal 50 from among the plurality of small cells C30 based on the acquired pass-through time parameters.

By this configuration of the base station 10, it is possible to remove small cells C30 where the time desired to pass through is small, that is, small cells C30 that are highly probable to frequently cause change of the candidates of S-Cell, from the candidates of S-Cell. Thereby, it is possible to reduce the traffic of the control signal.

The parameter acquisition unit 15 acquires a parameter related to the cell radius of each of a plurality of small cells C30 and the moving speed of the terminal 50 as the pass-through time parameter. Then, the cell control unit 16 selects the candidates of S-Cell for the terminal 50 based on the magnitude relation between the ratio between the cell radius and the moving speed of the terminal 50 and the first threshold value.

By this configuration of the base station 10, it is possible to remove small cells C30 whose cell radius is small compared with the moving speed of the terminal 50, that is, small cells C30 that are highly probable to frequently cause change of the candidates of S-Cell, from the candidates of S-Cell.

The cell control unit 16 selects cells, whose ratio of the moving speed of the terminal 50 to the cell radius is smaller than the first threshold value and whose distance from the terminal 50 is smaller than or equal to the second threshold value, from among a plurality of small cells C30 as the candidates of S-Cell.

By this configuration of the base station 10, it is possible to remove small cells C30 which the terminal 50 takes time to reach.

The cell control unit 16 may select small cells C30, whose ratio of the moving speed of the terminal 50 to the cell radius is smaller than the first threshold value, whose distance from the terminal 50 is smaller than or equal to the second threshold value, and whose cell radius is greater than the cell radius threshold value, from among a plurality of small cells 30 as the candidates of S-Cell.

By this configuration of the base station 10, it is possible to more efficiently remove small cells C30 that are highly probable to frequently cause change of the candidates of S-Cell from the candidates of S-Cell.

The cell control unit 16 may set the second threshold value so that the higher the moving speed of the terminal 50, the greater the second threshold value. Thereby, it is possible to adjust the selection parent population of the S-Cell candidates according to the moving speed of the terminal 50.

The cell control unit 16 may set the cell radius threshold value so that the greater the distance between the terminal 50 and each of a plurality of small cells C30, the greater the cell radius threshold value. Thereby, it is possible to adjust the selection parent population of the S-Cell candidates by considering the time which the terminal 50 takes to reach the small cells C30.

The cell control unit 16 may set the cell radius threshold value so that the higher the moving speed of the terminal 50, the greater the cell radius threshold value. Thereby, it is possible to remove small cells C30 that are highly probable to frequently cause change of the candidates of S-Cell from the candidates of S-Cell.

The cell control unit 16 may preferentially select small cells C30 in descending order of the cell radius as the candidates of S-Cell. Thereby, it is possible to preferentially select small cells C30 that are less probable to cause change of the candidates of S-Cell as the candidates of S-Cell.

The cell control unit 16 may preferentially select cells in ascending order of the distance between the cell and the terminal 50 as the candidates of S-Cell. Thereby, it is possible to remove small cells C30 which the terminal 50 takes time to reach.

### Second Embodiment

A second embodiment relates to a hardware configuration example of a base station corresponding to a macro cell. In the second embodiment, cell control is performed in a layer higher than a layer 2 (L2).

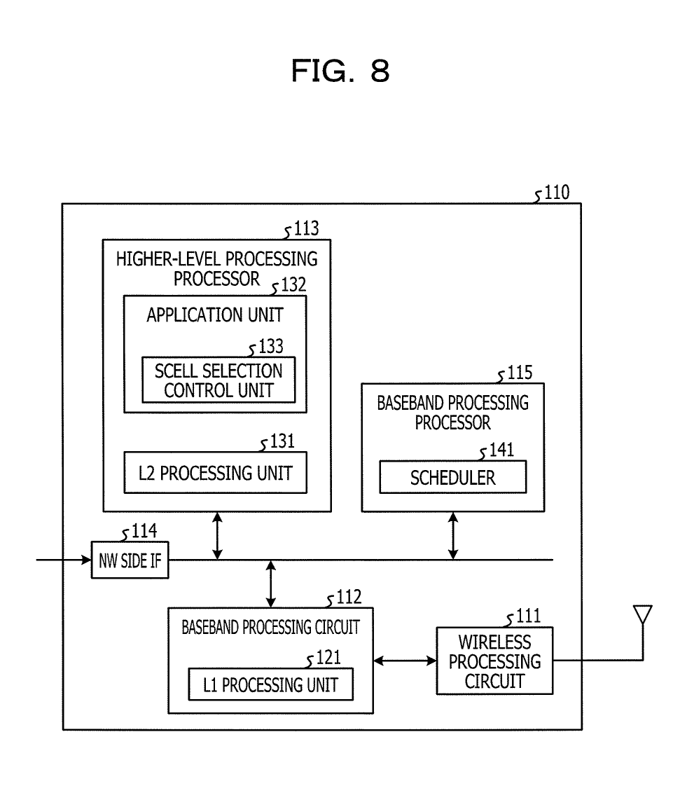

FIG. 8 is a diagram illustrating the hardware configuration example of the base station of the second embodiment. In FIG. 8, the base station 110 includes a wireless processing circuit 111, a baseband processing circuit 112, a higher-level processing processor 113, a network (NW) side IF 114, and a baseband processing processor 115. The baseband processing circuit 112 includes an L1 processing unit 121. The higher-level processing processor 113 includes an L2 processing unit 131 and an application unit 132. The application unit 132 includes an SCell selection control unit 133. In other words, processing of the SCell selection control unit 133 is performed in a higher-level layer (for example, an application layer) higher than the layer 2. The baseband processing processor 115 includes a scheduler 141.

The base station 110 corresponds to the base station 10 of the first embodiment. The SCell selection control unit 133 corresponds to the parameter acquisition unit 15 and the cell control unit 16 of the first embodiment. The wireless processing circuit 111 corresponds to the wireless reception unit 11 and the wireless transmission unit 18 of the first embodiment. The baseband processing circuit 112 corresponds to the reception processing unit 12, the transmission processing unit 17, and the terminal speed estimation unit 13 of the first embodiment. The NW side IF 114 corresponds to the network IF 14 of the first embodiment.

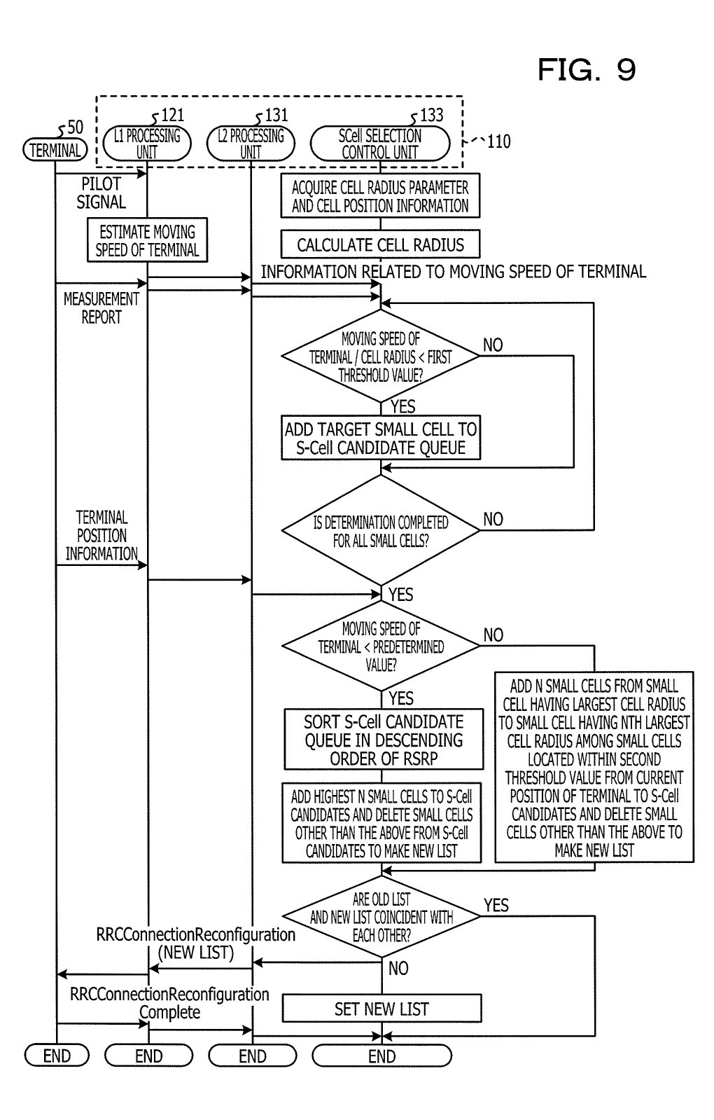

FIG. 9 is a diagram illustrating an example of a processing operation of the base station of the second embodiment. In FIG. 9, the SCell selection control unit 133 performs processing in the higher-level layer, so that the SCell selection control unit 133 transmits the new list to the terminal 50 by including the new list in the RRCConnectionReconfiguration message. The other processing steps of the SCell selection control unit 133 illustrated in FIG. 9 are the same as those described in FIG. 4, so that the description thereof will be omitted.

### Third Embodiment

A third embodiment relates to another hardware configuration example of the base station corresponding to the macro cell. In the third embodiment, cell control is performed in the layer 2 (L2).

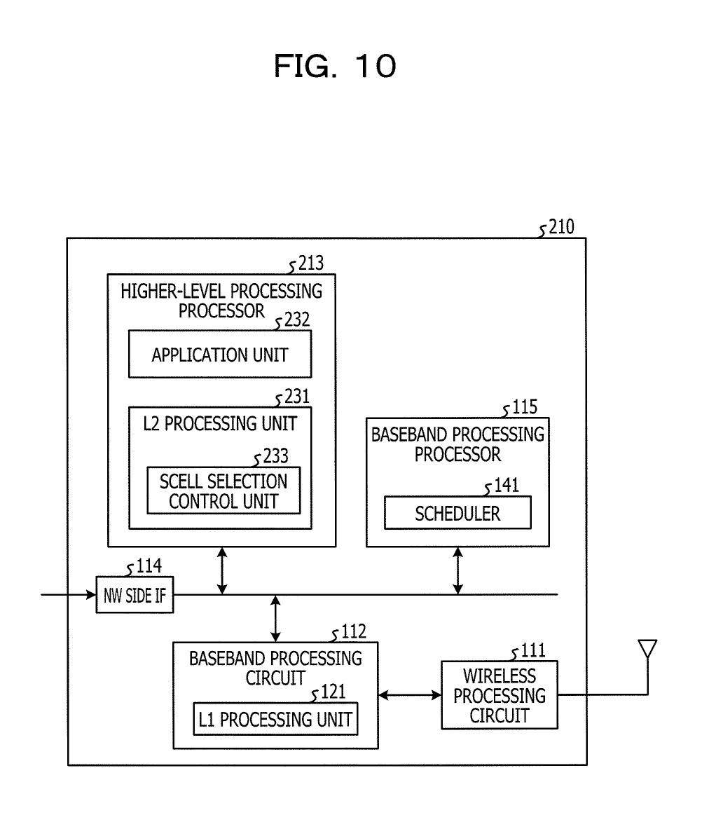

FIG. 10 is a diagram illustrating the hardware configuration example of the base station of the third embodiment. In FIG. 10, a base station 210 includes a higher-level processing processor 213. The higher-level processing processor 213 includes an L2 processing unit 231 and an application unit 232. The L2 processing unit 231 includes an SCell selection control unit 233. In other words, processing of the SCell selection control unit 233 is performed in the layer 2.

The base station 210 corresponds to the base station 10 of the first embodiment. The SCell selection control unit 233 corresponds to the parameter acquisition unit 15 and the cell control unit 16 of the first embodiment.

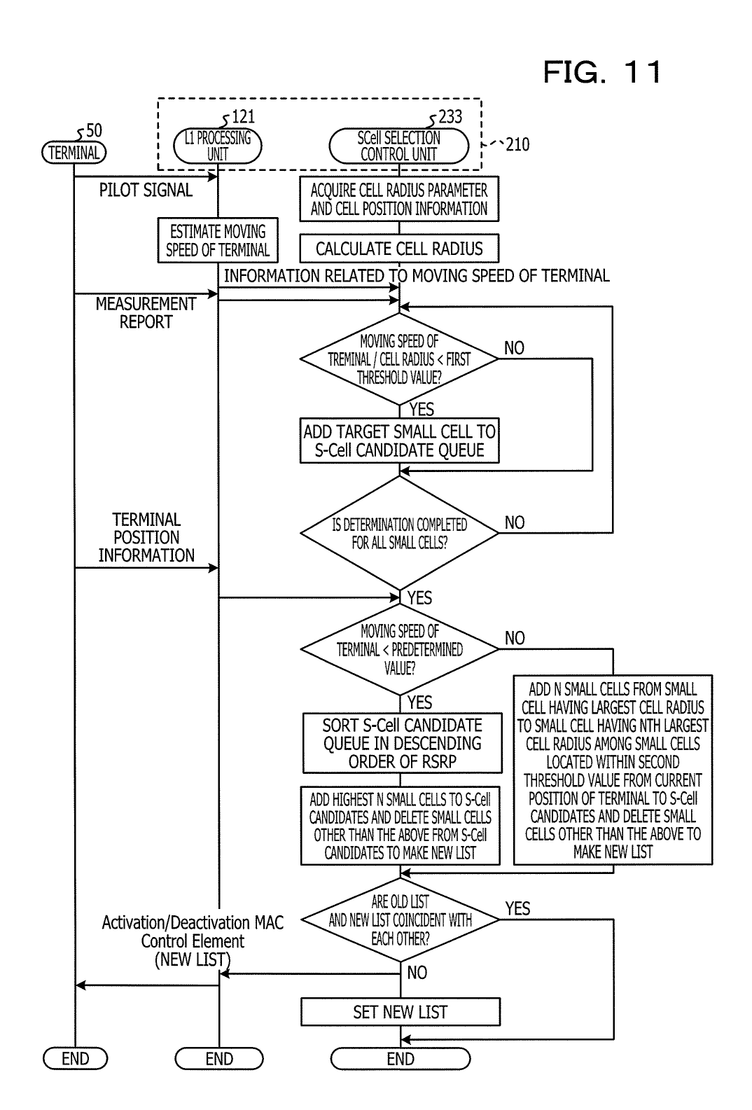

FIG. 11 is a diagram illustrating an example of a processing operation of the base station of the third embodiment. In FIG. 11, the SCell selection control unit 233 performs processing in the layer 2, so that the SCell selection control unit 233 transmits the new list to the terminal 50 by including the new list in an Activation/DeactivationMACControlElement message. The other processing steps of the SCell selection control unit 233 illustrated in FIG. 11 are the same as those described in FIG. 4, so that the description thereof will be omitted.

### Other Embodiments

The constituent elements of each unit illustrated in the drawings in the first embodiment do not have to be physically configured as illustrated in the drawings. In other words, specific forms of distribution and integration of the units are not limited to those illustrated in the drawings, and all or part of the units can be functionally or physically distributed or integrated in arbitrary units according to various loads and the state of use.

Further, all or any part of various processing functions performed in each device may be implemented on a CPU (Central Processing Unit) (or a microcomputer such an MPU (Micro Processing Unit) and an MCU (Micro Controller Unit)). All or any part of the various processing functions may be implemented on a program analyzed and executed by a CPU (or a microcomputer such as an MPU and an MCU) or on hardware using wired logic.

It is possible to realize the base station of the first embodiment by, for example, the following hardware configuration.

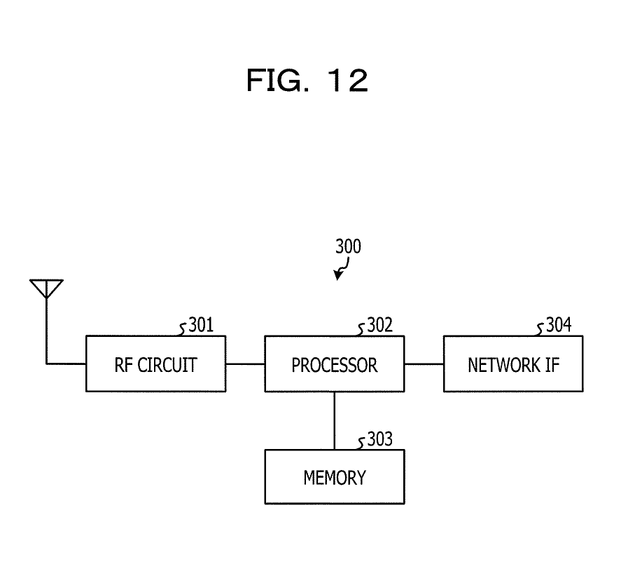

FIG. 12 is a diagram illustrating another hardware configuration example of the base station. As illustrated in FIG. 12, a base station 300 corresponding to a macro cell includes an RF (Radio Frequency) circuit 301, a processor 302, a memory 303, and a network IF (Inter Face) 304. Examples of the processor 302 include a CPU, a DSP (Digital Signal Processor), and an FPGA (Field Programmable Gate Array). Examples of the memory 303 include a RAM (Random Access Memory) such as an SDRAM (Synchronous Dynamic Random Access Memory), a ROM (Read Only Memory), and a flash memory.

Various processing functions performed in the base station corresponding to the macro cell of the first embodiment may be realized by executing a program stored in various memories such as a non-volatile storage medium by a processor included in an amplifying device. In other words, programs corresponding to various processes performed by the reception processing unit 12, the terminal speed estimation unit 13, the parameter acquisition unit 15, the cell control unit 16, and the transmission processing unit 17 may be stored in the memory 303 and each program may be executed by the processor 302.

Here, the base station 300 is described assuming that the base station 300 is an integrated device. However, it is not limited to this. For example, the base station 300 may be configured by two separate devices, that is, a wireless device and a control device. In this case, for example, the RF circuit 301 is arranged in the wireless device, and the processor 302, the memory 303, and a network IF 304 are arranged in the control device.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A base station comprising:
an antenna configured to wirelessly communicate with a terminal that is able to communicate with the base station and another base station in parallel, the other base station being selected from a plurality of other base stations; and
a processor configured to select the other base station based on a plurality of at least one parameter, each at least one parameter being associated with each period during which the terminal stays in each cell formed by each of the plurality of other base stations.

2. The base station according to claim 1, wherein
each at least one parameter includes each first parameter that is associated with each size of each cell.

3. The base station according to claim 2, wherein
each at least one parameter further includes a second parameter that is associated with a moving speed of the terminal.

4. The base station according to claim 2, wherein
the processor is configured to select the other base station further based on each third parameter that is associated with each distance between the terminal and each cell.

5. The base station according to claim 3, wherein
the processor is configured to select the other base station based on each ratio of each second parameter to each first parameter.

6. The base station according to claim 3, wherein
the processor is configured to select the other base station further based on each third parameter that is associated with each distance between the terminal and each cell,
each third parameter is compared with each first threshold, and
each first threshold is larger as each second parameter is larger.

7. The base station according to claim 4, wherein
each first parameter is compared with each second threshold, and
each second threshold is larger as each third parameter is larger.

8. The base station according to claim 3, wherein
each first parameter is compared with each second threshold, and
each second threshold is larger as each second parameter is larger.

9. The base station according to claim 2, wherein
the processor is configured to preferentially select the other base station from each first other base station of which each size of each cell is larger.

10. The base station according to claim 4, wherein
the processor is configured to preferentially select the other base station from each second other base station of which each distance between the terminal and each cell is smaller.

11. The base station according to claim 1, wherein
each cell formed by each of the plurality of other base stations is located within a cell formed by the base station.

12. The base station according to claim 1, wherein
the terminal is able to communicate with the base station and the other base station in parallel by performing carrier aggregation (CA),
the base station is primary cell (P-cell) of CA, and
the other base station is secondary cell (S-cell) of CA.

13. A cell selection method comprising:
wirelessly communicating with a terminal that is able to communicate with the base station and another base station in parallel, the other base station being selected from a plurality of other base stations; and
selecting the other base station based on a plurality of at least one parameter, each at least one parameter being associated with each period during which the terminal stays in each cell formed by each of the plurality of other base stations.
